(19) United States
(12) Patent Application Publication
(10) Pub. No.: US 2008/0073570 A1
(43) Pub. Date: Mar. 27, 2008

(54) Method of repeatedly using a control wafer to monitor treatments

(76) Inventor: Yu-Hsien Chen, Taipei City (TW)

Correspondence Address: J.C. Patents, Inc., Suite 250, 4 Venture, Irvine, CA, 92618, US

(21) Appl. No.: 11/484,375

(22) Filed: Jul. 10, 2006

(51) Int. Cl. G21G 5/00

(52) U.S. Cl. 250/492.1

(57) ABSTRACT

A method of repeatedly using a control wafer to monitor treatments is described. The method includes (a) forming a patterned mask layer with at least one opening therein on a control wafer, wherein the opening is located at a position of the control wafer; (b) performing a treatment to the control wafer through the opening; (c) performing a measurement at the position of the control wafer; (d) removing the patterned mask layer; and (e) repeating steps (a) to (d) for multiple cycles, wherein the opening is formed at a different position in each cycle.

### BACKGROUND OF THE INVENTION

1. Field of Invention

The present invention relates to a method of using a control wafer in integrated circuit (IC) fabrication, and more particularly, to a method of repeatedly using a control wafer to monitor treatments in IC fabrication.

2. Description of Related Art

IC devices are used in many applications in our daily life, including electronic products for consumers and for national defense like audio, TV, radar and cell phones, except the well-known computer applications.

Since the fabrication of an IC device is quite complicated and includes hundreds of steps consuming 1-2 months, accuracy is a very important issue to each step. Hence, many control wafers are used to monitor the steps and inspect whether the processing conditions of the steps meet the requirements or not, so that process errors are decreased in time lowering the possibility of die damage or waste and thereby reducing the cost.

In an ion implantation process, for example, a control wafer never used before is usually used for precisely controlling the dopant profile, especially the doping depth and the lateral concentration distribution. The monitor for stability of the ion implanter can be done by forming a screen layer on the control wafer, performing ion implantation to the control wafer and then measure the thermal wave (TW) intensity of the same.

However, since IC manufacture includes many ion implantation processes, many control wafers are required. When the throughput of a semiconductor fab is raised, the increased cost for more control wafers prevents the production cost from being reduced.

A prior-art method of reducing the cost for control wafers is to recycle a control wafer by polishing away the screen layer and forming a new screen one or by annealing the wafer to repair the surface bonding thereof previously damaged by the implantation.

Though the above methods can reduce the number of control wafers required, the cost for the polishing method is still high because polishing away the screen layer mostly needs outsourcing. On the other hand, since the stability of a control wafer is degraded with increased number of times of the recycle when the annealing method is applied, the number of times of the recycle is limited to 3 or 4. Moreover, the above recycle methods are quite complicated, and cannot be used to monitor a control wafer used to monitor the stability of high-current ion implanters. Therefore, it is currently desired to increase the number of times of recycling a control wafer as well as simplify the recycle process, so as to reduce the manufacturing cost.

### SUMMARY OF THE INVENTION

In view of the foregoing, this invention provides a method of repeatedly using a control wafer to monitor treatments, which is capable of increasing the number of times of recycling a control wafer as well as simplifying the recycle process.

This invention also provides a method of monitoring an ion implantation process, which is based on the method of repeatedly using a control wafer of this invention.

The method of repeatedly using a control wafer to monitor treatments of this invention includes (a) forming a patterned mask layer with at least one opening therein on a control wafer, wherein the opening is located at a position of the control wafer; (b) performing a treatment to the control wafer through the opening; (c) performing a measurement at the position of the control wafer; (d) removing the patterned mask layer; and (e) repeating steps (a) to (d) for multiple cycles, wherein the opening is formed at a different position in each cycle.

In an embodiment, the control wafer includes multiple areas and in each cycle, an opening is formed on each of the areas. The openings formed in different cycles may be formed by using the same photomask or by using different photomasks.

In addition, the above method may further use a computer program to control the monitors for different positions of the control wafer. The method may further utilize a distinguishing method that records the positions having been treated or forms marks at the positions having been treated, so that the positions having been treated can be identified and are not used again. The treatments may include at least one of ion implantation, plasma treatment and UV irradiation.

Moreover, in the above method of this invention, the measurement may include a destructive measurement or non-destructive measurement. The non-destructive one may include a measurement utilizing laser or UV irradiation, while the destructive one may include a probe measurement.

In addition, the treatments may be all the same or include different treatments.

The method of monitoring an ion implantation process of this invention is based on the above method of repeatedly using a control wafer of this invention, including (a) forming a patterned mask layer with at least one opening therein on a control wafer, wherein the opening is located at a position of the control wafer; (b) performing ion implantation to the control wafer through the opening; (c) performing a measurement at the position of the control wafer; (d) removing the patterned mask layer; and (e) repeating steps (a) to (d) for multiple cycles, wherein the opening is formed at a different position in each cycle.

In an embodiment, the control wafer includes multiple areas, and in each cycle, an opening is formed on each of the areas. The openings formed in different cycles may be formed by using the same photomask or by using different photomasks.

In addition, the method may further include using a computer program to control the monitors for different positions of the control wafer. The method may further include utilizing a distinguishing method that records the positions having been treated or forms marks at the positions having been treated, so that the positions having been treated can be identified and are not used again.

Moreover, in the above method of this invention, the ion implantation process may include a medium-current ion implantation process or a high-current implantation process. The measurement may include measuring a thermal wave intensity at the position of the control wafer.

Furthermore, in the above method of this invention, the measurement may include a destructive measurement or a non-destructive measurement. The non-destructive one may include a measurement utilizing laser or UV irradiation, while the destructive one may include a probe measurement.

Since this invention treats a different position of a control wafer each time, the control wafer can be repeatedly used without being polished or annealed, and stability of the control wafer is not degraded by previous treatments. Meanwhile, the control wafer can be used to repeatedly monitor a high-current ion implantation, for which a control wafer even cannot be recycled in the prior art. Therefore, the recycle process of a control wafer can be simplified, and the number of times of recycling a control wafer can be much increased.

In order to make the aforementioned and other objects, features and advantages of the present invention comprehensible, a preferred embodiment accompanied with figures is described in detail below.

### BRIEF DESCRIPTION OF THE DRAWINGS

FIG. 1 shows a flow chart of a method of repeatedly using a control wafer to monitor treatments according to an embodiment of this invention.

FIGS. 2A-2D illustrate a process flow of a method of repeatedly using a control wafer to monitor treatments according to an embodiment of this invention.

FIG. 3 illustrates an example of a control wafer that includes multiple areas monitored simultaneously in each cycle according to an embodiment of this invention.

### DESCRIPTION OF EMBODIMENTS

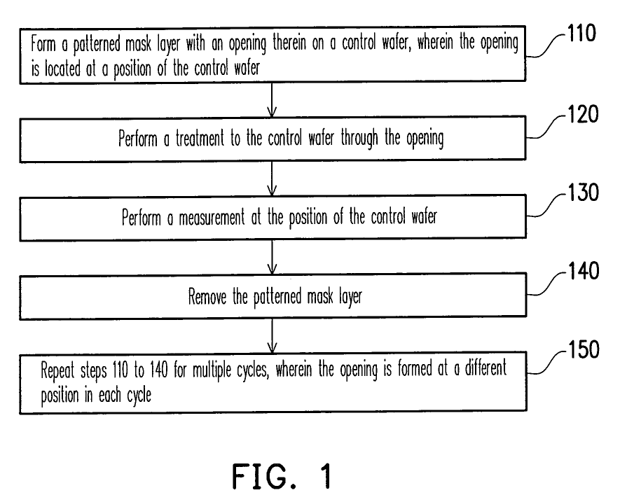

FIG. 1 shows a flow chart of a method of repeatedly using a control wafer to monitor treatments according to an embodiment of this invention.

Referring to FIG. 1, a patterned mask layer with at least one opening therein is formed on a control wafer in step 110, wherein the opening is located at a position of the control wafer. The control wafer may be one never used before, such as a bare Si-wafer. The patterned mask layer may be a patterned photoresist layer, possibly formed by forming a photoresist material layer on the control wafer with spin coating, exposing with a photomask having an opening pattern thereon and then developing the same.

In step 120, a treatment is performed to the control wafer through the opening. The treatment may be a surface treatment to the control wafer like ion implantation, plasma treatment or UV irradiation, depending on the type of the treatment done to the product wafers. For example, when an ion implantation to the product wafers is to be monitored, the control wafer is subject to the same implantation process where the species of the dopant, the dopant concentration, the implantation depth and the chamber conditions, etc., are the same as those of the ion implantation to the product wafers.

In next step 130, a measurement is performed at the position of the control wafer for a specific property of the portion of the control wafer at the position, wherein the type of the measurement depends on the type of the treatment. The measurement may include a destructive measurement or a non-destructive measurement, wherein the non-destructive measurement may include a measurement utilizing laser or UV irradiation, while the destructive measurement may include a probe measurement.

In step 140, the patterned mask layer is removed. In next step 150, steps 110 to 140 are repeated for multiple cycles, wherein in each cycle, the opening is formed at a different position of the control wafer. Since the opening is formed at a different position in each cycle, the treatment is done to and the measurement is conducted at a different position in each cycle. Therefore, the control wafer can be repeatedly used without being subject to polishing or annealing, so that the recycle process of control wafers is simplified and the corresponding cost is reduced. Meanwhile, the stability of the control wafer is not degraded by previous treatments for no portion thereof is treated or measured twice, so that the number of times of recycling a control wafer is increased.

Moreover, since a product wafer often has thereon a patterned mask layer like a patterned photoresist layer and this invention also forms a patterned mask layer, the real fabrication conditions of the product wafers can be simulated better with this invention and the vacuating performance of the treating machine can also be monitored.

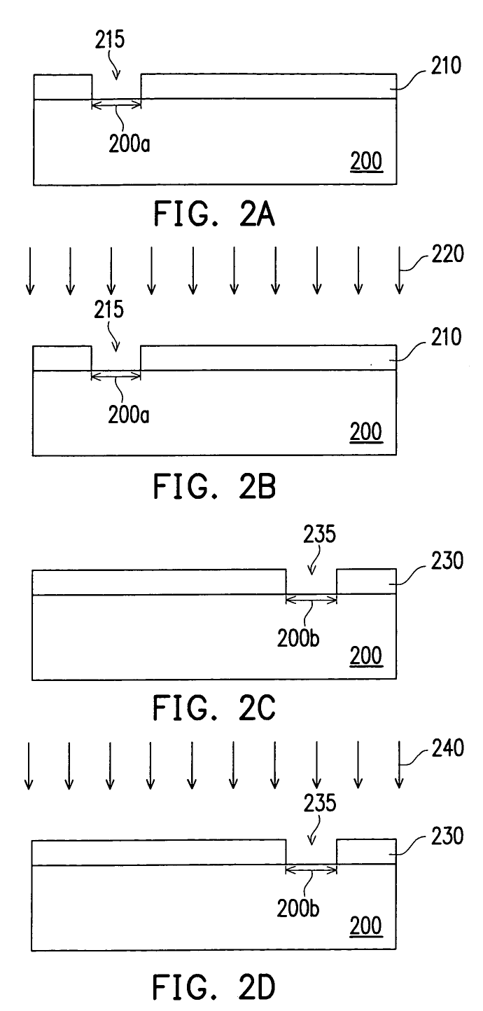

FIGS. 2A-2D illustrate a process flow of a method of repeatedly using a control wafer to monitor treatments according to an embodiment of this invention.

Referring to FIG. 2A, a patterned mask layer 210 is formed on a control wafer 200, having therein an opening 215 at a position 200a of the control wafer 200, wherein the control wafer 200 may be a bare Si-wafer never used before. The patterned mask layer 210 may be a patterned photoresist layer, and may be formed by forming a layer of photoresist material on the control wafer 200 with spin coating, exposing with a photomask having thereon an opening pattern corresponding the opening 215 and then developing the same.

Referring to FIG. 2B, a treatment 220 is performed to the control wafer 200 through the opening 215. The treatment 220 may be a surface treatment to the control wafer 200 like ion implantation, plasma treatment or UV irradiation, depending on the type of the same treatment done to the product wafers (not shown). For example, when an ion implantation to the product wafers is to be monitored, the control wafer 200 is subject to the same implantation process where the species of the dopant, the dopant concentration, the implantation depth and the chamber conditions, etc., are the same as those of the ion implantation to the product wafers. The ion implantation process may include a medium-current or high-current implantation process, wherein the former/latter is done with a medium-current/high-current implanter.

Since the pattern mask layer 210 is present on the control wafer 200 during the treatment 220, only the portion of the control wafer 200 exposed in the opening 215 is subject to the treatment 220. The rest of the control wafer 200 covered and protected by the pattern mask layer 210 is not affected by the treatment 220 and therefore can be used in subsequent monitors.

Then, a measurement is performed at the position 200a of the control wafer 200 for a specific property of the corresponding portion of the control wafer 200, wherein the type of the measurement depends on the type of the treatment. The measurement may include a destructive measurement or a non-destructive measurement, wherein the non-destructive one may include a measurement utilizing laser or V irradiation and the destructive one may include a probe measurement.

For example, a measurement for monitoring ion implantation can be done by using a probe to contact the surface of the control wafer 200 and measure the sheet resistance (Rs), or by using a laser to heat the position 200a of the control wafer 200 and measuring the thermal wave (TW) intensity emitted from the same. The dose of the implantation can be derived from the thermal wave intensity, for the later corresponds to the degree of the control wafer 200 being damaged by the implanted ions.

Alternatively, a measurement may be one for the number of mobile ions or the charge density at the surface of the control wafer 200, depending on the process design.

Referring to FIG. 2C, the patterned mask layer 210 is removed, and then another patterned mask layer 230 is formed on the control wafer 200, having therein an opening 235 at a position 200b of the control wafer 200 that is different from the position 200a. The material and the forming method of the patterned mask layer 230 may be the same as those of the patterned mask layer 210. In addition, the opening 235 may be defined by the same photomask used to define the opening 215 or by a different photomask.

It is also noted that though the position 200b is distant from the position 200a in FIG. 2C, the arrangement of the positions 200a and 200b is not limited to the illustrated one. The positions 200a and 200b may be formed very close to each other if only not overlapping with each other.

Referring to FIG. 2D, another treatment 240 is done to the control wafer 200 through the opening 235. The treatment 240 may be a surface treatment to the control wafer 200 like ion implantation, plasma treatment or UV irradiation, and may be the same as or different from the treatment 220 in their conditions or even their types. For example, if the treatment 220 is an ion implantation under a condition A, the treatment 240 may be an ion implantation under the same condition A, an ion implantation under a different condition B, or even another type of treatment like plasma treatment.

Then, a measurement is performed at the position 200b of the control wafer 200 for a specific property of the portion of the control wafer 200 at the position 200b. The measurement may include a destructive measurement or a non-destructive measurement, wherein the non-destructive one may include a measurement utilizing laser or UV irradiation, while the destructive one may include a probe measurement.

It is particularly noted that since the position 200b of the control wafer 200 is covered/protected by the patterned mask layer 210 during the precedent treatment 220, the corresponding portion of the control wafer 200 is like a portion of a control wafer never used before and therefore can be used to monitor the treatment 240 accurately. The control wafer 200 is thus recycled for subsequent monitors.

It is also noted that the above-mentioned steps of forming a patterned mask layer, performing a treatment and a measurement as well as removing the patterned mask layer can be readily repeated for multiple cycles, until all positions of the control wafer 200 have been treated and measured.

The above method of repeatedly using a control wafer is quite simple, and can be done without outsourcing polishing or annealing. Meanwhile, because the portions covered by the patterned mask layer are not treated, the properties of the control wafer are not changed due to repeated use. Thus, a control wafer 200 can be used much more times reducing the cost for control wafers.

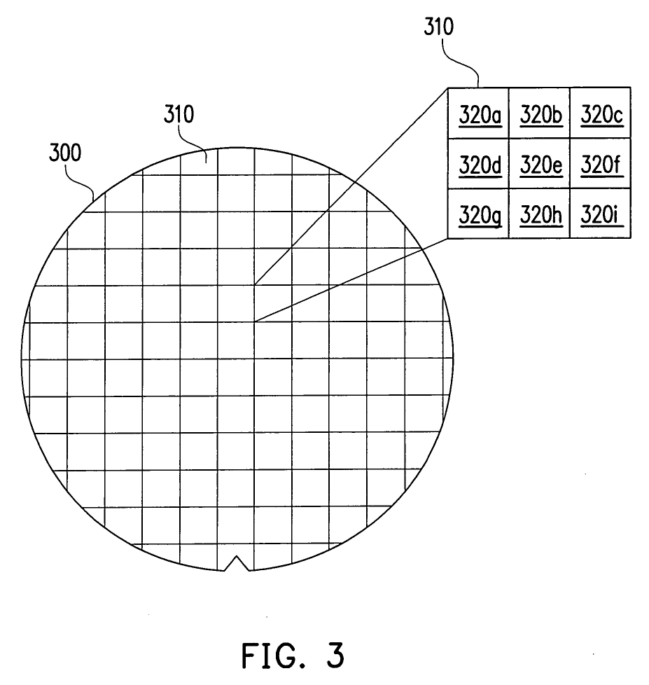

To further explain the way of selecting a different position of the control wafer to be treated and measured in each cycle, the following embodiment is provided. FIG. 3 illustrates an example of a control wafer including multiple areas simultaneously monitored in each cycle according to the embodiment.

Referring to FIG. 3, the control wafer 300 includes many areas 310, wherein the number of the areas 310 may be 27 or more, and each area 310 is divided into multiple portions, such as nine portions 320a-302i as shown in FIG. 3. The multiple portions do not overlap with each other, and each portion is used in a different cycle. In each cycle of monitor, an opening may be formed on one portion of each area 310. Thus, when the number of areas 300 reaches a certain value, every part of the control wafer 300 can have a portion being treated and measured in each cycle so that the uniformity of the treatment effect to the product wafers can be monitored.

In addition, when the number of the portions divided from an area 310 is increased, the control wafer can be repeatedly used more times. The reason why each area 310 can be divided into multiple portions to be used in many cycles is that the area of the control wafer 300 required for the monitor in each cycle is relatively small.

In an example of using the control wafer 300, a patterned mask layer is firstly formed on the control wafer 300, having openings therein to expose the portion 320a of each of the areas 310. After a treatment and a measurement are made through the openings, the patterned mask layer is removed.

Moreover, to make sure that the openings formed in next cycle are not on the portions 320a having been treated, it is possible to utilize a distinguishing method that records the positions of the portions 320a or forms marks on the portions 320a after the patterned mask layer is removed so that the portions 320a having been used can be identified later. The record may be made on a flow control card that may be put in the wafer pod for carrying the control wafer 300, and an engineer can immediately know which positions have been treated according to the record on the flow control card. In an embodiment where marks are formed on the positions having been treated, a laser mark may be formed at each position having been treated, and a detector can be used to detect the laser mark and identify whether a position has been treated or not.

Thereafter, another patterned mask layer is formed on the control wafer 300, having openings therein to expose the portion 320b of each area 310. After a treatment and a measurement of another cycle are made through the openings, the patterned mask layer is removed. Subsequent monitors can be made accordingly.

Since this embodiment forms an opening on a portion of each of multiple areas of the control wafer with one photomask, the uniformity of the treatment effect to the product wafers and the vacuating capability of the treating machine can be monitored.

Moreover, in some examples, a computer program may be used to set different monitor modes for different positions of the control wafer 300, so as to accurately monitor the effect of the treatment to different positions of the control wafer 300.

The present invention has been disclosed above in the preferred embodiments, but is not limited to those. It is known to persons skilled in the art that some modifications and innovations may be made without departing from the spirit and scope of the present invention. Therefore, the scope of the present invention should be defined by the following claims.

What is claimed is:

1. A method of repeatedly using a control wafer to monitor treatments, comprising
(a) forming a patterned mask layer with at least one opening therein on a control wafer, wherein the opening is located at a position of the control wafer;
(b) performing a treatment to the control wafer through the opening;
(c) performing a measurement at the position of the control wafer;
(d) removing the patterned mask layer; and
(e) repeating steps (a) to (d) for a plurality of cycles, wherein the opening is formed at a different position in each cycle.

2. The method of claim 1, wherein the control wafer includes a plurality of areas and in each cycle, an opening is formed on each of the areas.

3. The method of claim 1, wherein the openings formed in different cycles are formed by using the same photomask or by using different photomasks.

4. The method of claim 1, further comprising using a computer program to control the monitors for different positions of the control wafer.

5. The method of claim 1, further comprising utilizing a distinguishing method that records the positions having been treated or forms marks at the positions having been treated, so that the positions having been treated can be identified.

6. The method of claim 1, wherein the treatments comprise at least one of ion implantation, plasma treatment and UV irradiation.

7. The method of claim 1, wherein the measurement comprises a destructive measurement or a non-destructive measurement.

8. The method of claim 7, wherein the non-destructive measurement comprises a measurement utilizing laser or UV irradiation.

9. The method of claim 7, wherein the destructive measurement comprises a probe measurement.

10. The method of claim 1, wherein the treatments are all the same or include different treatments.

11. A method of monitoring an ion implantation process, comprising:
(a) forming a patterned mask layer with at least one opening therein on a control wafer, wherein the opening is located at a position of the control wafer;
(b) performing ion implantation to the control wafer through the opening;
(c) performing a measurement at the position of the control wafer;
(d) removing the patterned mask layer; and
(e) repeating steps (a) to (d) for a plurality of cycles, wherein the opening is formed at a different position in each cycle.

12. The method of claim 11, wherein the control wafer includes a plurality of areas and in each cycle, an opening is formed on each of the areas.

13. The method of claim 11, wherein the openings formed in different cycles are formed by using the same photomask or by using different photomasks.

14. The method of claim 11, further comprising using a computer program to control the monitors for different positions of the control wafer.

15. The method of claim 11, further comprising utilizing a distinguishing method that records the positions having been treated or forms marks at the positions having been treated so that the positions having been treated can be identified.

16. The method of claim 11, wherein the ion implantation process comprises a medium-current ion implantation process or a high-current ion implantation process.

17. The method of claim 11, wherein the measurement comprises measuring a thermal wave intensity at the position of the control wafer.

18. The method of claim 11, wherein the measurement comprises a destructive measurement or a non-destructive measurement.

19. The method of claim 18, wherein the non-destructive measurement comprises a measurement utilizing laser or UV irradiation.

20. The method of claim 18, wherein the destructive measurement comprises a probe measurement.
